(19) United States
(12) Patent Application Publication
(10) Pub. No.: US 2009/0051532 A1
(43) Pub. Date: Feb. 26, 2009

(54) WIRELESS TECHNOLOGY FOR VARIOUS PRODUCT/PEOPLE LIGHTING SOLUTIONS

(75) Inventor: Luc Van Der Poel, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELCTRONICS, N.V., ENDHOVEN (NL)

(21) Appl. No.: 11/718,419

(22) PCT Filed: Nov. 2, 2005
(86) PCT No.: PCT/IB2005/053578

§ 371 Date: May 2, 2007

Related U.S. Application Data
(60) Provisional application No. 60/624,797, filed on Nov. 3, 2004.

(51) Int. Cl. G08B 13/14

(52) U.S. Cl. 340/572.1

(57) ABSTRACT

A RFID based technology employs central computer(s) (10), reader/receiver(s) (11), lighting system(s) (12), product tag(s) (20), personal tag(s) (30), and/or shopping list(s) (40). Each product tag (20) includes integrated circuit(s) (21) and product data information (22), and optionally includes LEDs (23). Each personal tag 30 includes integrated circuit(s) (31) and personal data information (32). Each shopping list 40 includes circuit(s) (41) and a product shopping list (42). A wireless/wireline system is adapted from the RFID technology to provide product and personal lighting solutions.

The present invention generally relates to wireless technology. The present invention specifically relates to radio frequency identification (“RFID”) technology as implemented in product and people lighting solutions.

The Assignee of the present invention is the inventor and producer of the MIFARE® technology, which can be based on contactless and dual interface RFID smart cards having one or more integrated circuits (“IC”). Each RFID smart card allows for the reading of information store on that particular smart card by a RFID reader without visual contact. For example, a pushing of a trolley transporting products having RFID smart cards attached thereon facilitates a detection of a total price of the products by a RFID reader without any visual contact of the purchase price of each product by a person.

The lighting industry is continually striving to incorporate wireless technology to facilitate more and more product and/or people related lighting solutions. To this end, the present invention provides new and unique applications of a wireless technology (e.g., MIFARE® technology) to product and people related lighting solutions.

Forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

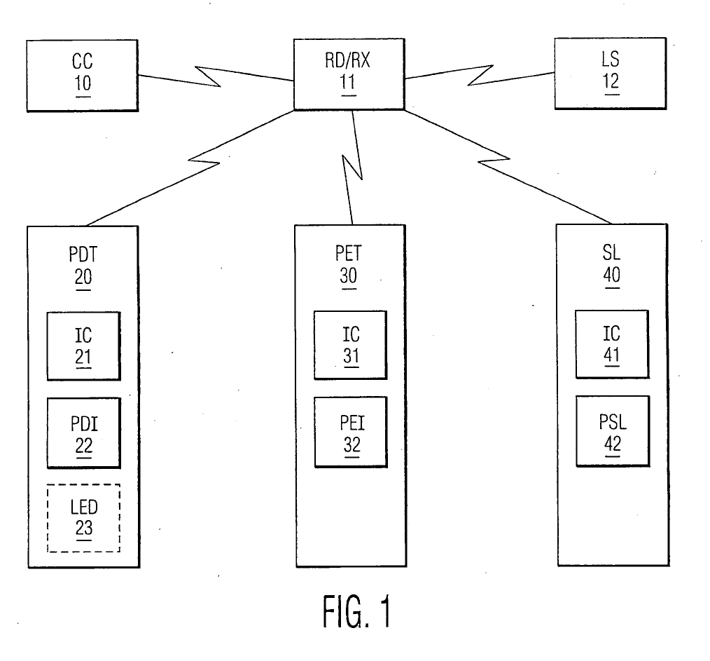

FIG. 1 illustrates an exemplary embodiment of a wireless system in accordance with the present invention;

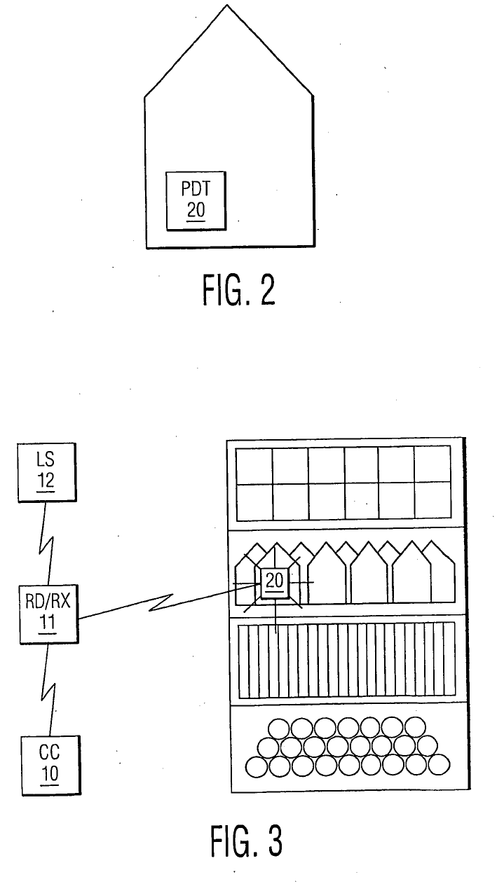

FIG. 2 illustrates an exemplary attachment of a product tag in accordance with the present invention to a product;

FIG. 3 illustrates an exemplary illumination of a product in accordance with a product tag of the present invention;

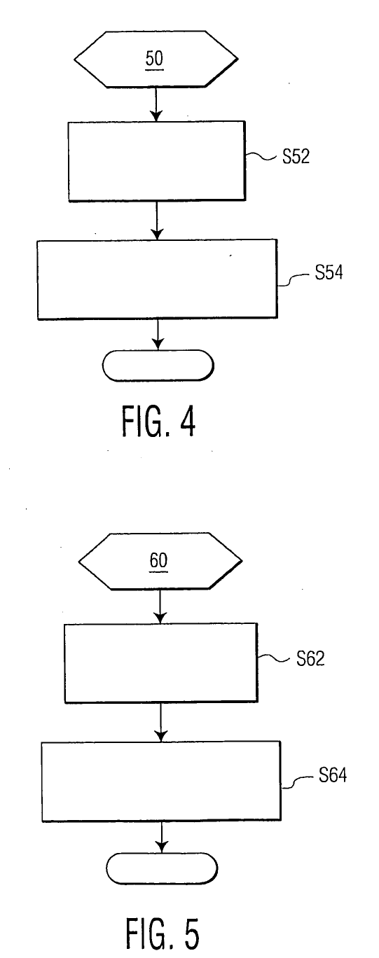

FIG. 4 illustrates a flowchart representative of a product illumination method in accordance with the present invention;

FIG. 5 illustrates a flowchart representative of a product pricing update method in accordance with the present invention;

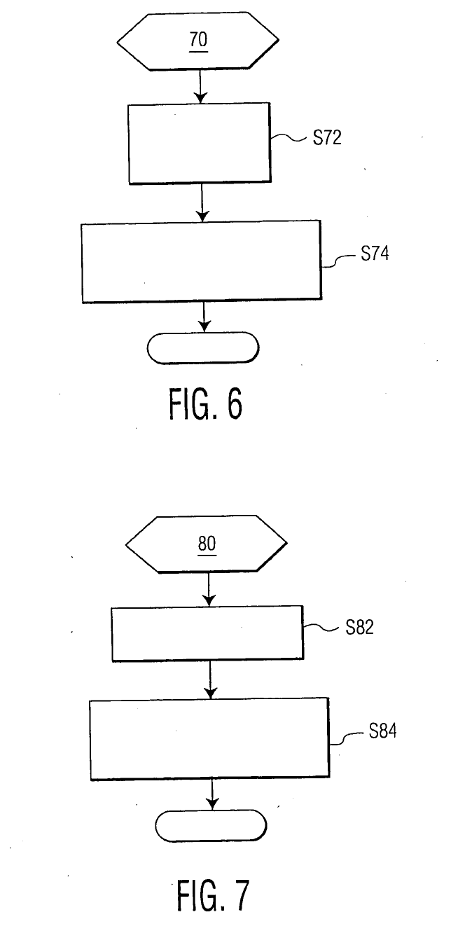

FIG. 6 illustrates a flowchart representative of a shopping list illumination method in accordance with the present invention;

FIG. 7 illustrates a flowchart representative of a personal illumination method in accordance with the present invention;

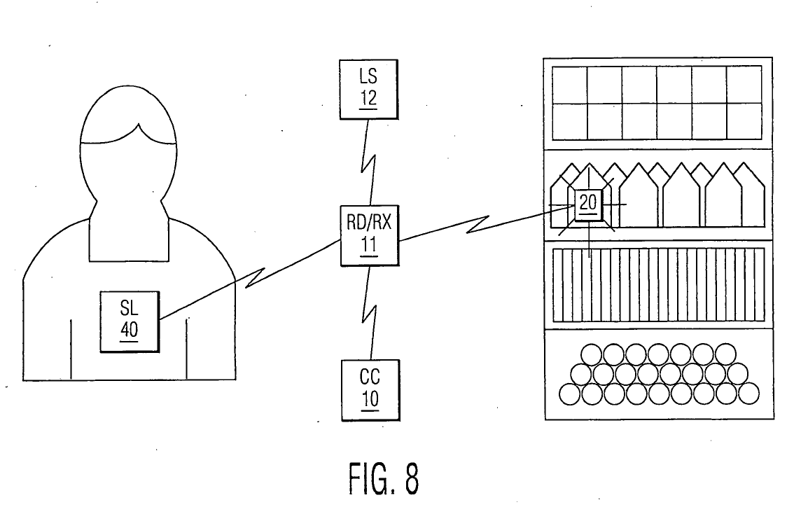

FIG. 8 illustrates an exemplary illumination of a product in accordance with a shopping list of the present invention;

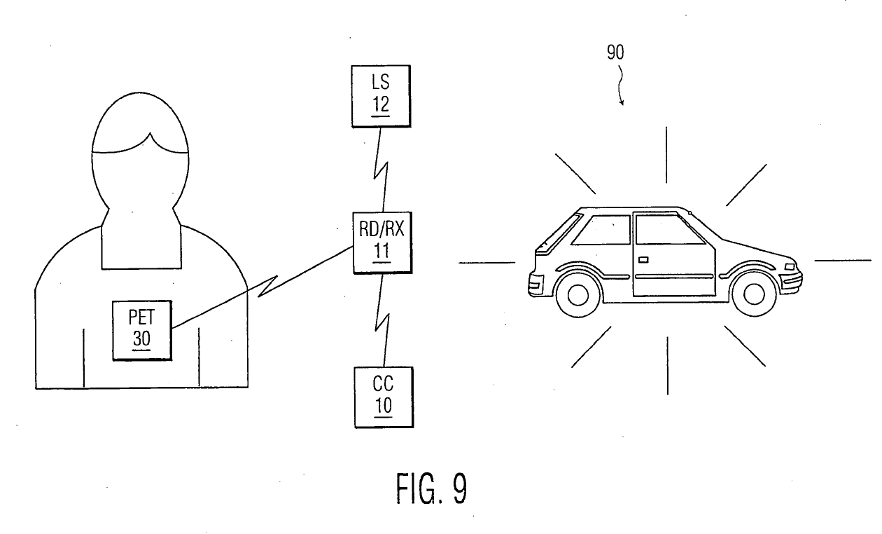

FIG. 9 illustrates an exemplary illumination of a product in accordance with a personal tag of the present invention.

Each product and people lighting solution by the present invention incorporates a specific grouping of RFID based technology (e.g., MIFARE® technology) components selected from a collection of such components illustrated in FIG. 1. Referring to FIG. 1, the collection includes a central computer (“CC”) 10, a reader/receiver (“RD/RX”) 11, a lighting system (“LS”) 12, a product tag (“PDT”) 20, a personal tag (“PET”) 30 and a shopping list (“SL”) 40. Product tag 20 is a RFID smart card including an integrated circuit (“IC”) 21 and product data information (“PDI”) 22, and optionally includes LEDs 23. Personal tag 30 is a RFID smart card including an integrated circuit (“IC”) 31 and personal data information (“PEI”) 32. Shopping list is a RFID smart card including an integrated circuit (“IC”) 41 and a product shopping list (“PSL”) 42.

The present invention utilizes the conventional wireless/wireline communication among the components as facilitated by reader/receiver 11 to implement several product/people lighting solutions. To this end, one or more readers 11 and one or more of the smart cards will be employed for each product/people lighting solution offered by the present invention, and one or more of central computer 10 and one or more of lighting system 12 may be employed for each product/people lighting solution offered by the present invention. When one or more product tags 20 are employed, one embodiment of product data information 22 includes information descriptive of the product and its packaging as well as information descriptive of a particular illumination scheme of the product. When one or more people tags 30 are employed, one embodiment of personal data information 32 includes information descriptive of various attributes of a person associated with the tag as well as information descriptive of a particular illumination scheme(s) of product(s) that are tailored to the physical attributes of the person associated with the tag. When one or more shopping lists 40 are employed, one embodiment of product shopping list 42 includes a listing of products selected for purchase by a person holding shopping list 40.

FIGS. 2-6 exemplarily illustrate various product/people lighting solutions offered by the present invention. The actual structural configurations of the various components 10, 11, 12, 20, 30 and 40 as illustrated in FIGS. 2-6 are dependent upon a specific implementation of the present invention in practice, and is therefore not provided herein. Nonetheless, from the description of FIGS. 2-6, those having ordinary skill in the art will appreciate any modification that may be needed to conventional technology for structurally configuring components 10, 11, 12, 20, 30 and 40 in implementing the product/people lighting solutions illustrated in FIGS. 2-6.

FIGS. 2 and 3 illustrate an attachment of a product tag 20 to a product package that is stored on a shelf with other products, similar and different. For one set of product lighting solutions, central computer 10, reader/receiver 11 and/or integrated circuit 21 implement a flowchart 50 (FIG. 4) having a stage S52 involving a reading of the product data information 22 on product tag 20 to obtain a desired illumination of the product illustrated in FIG. 2 and a stage S54 involving a control of either lighting system 12 and/or LEDs 23 to illuminate the product based on product data information 22.

In one exemplary embodiment of flowchart 50, the product data information 22 indicates which color within a color spectrum best illuminates a product whereby an implementation of flowchart 50 illuminates the product based on the indicated color via lighting system 12 and/or LEDs 23. For RGB based lighting system 12 and/or a RGB based LEDs 23, a per length section differential addressing scheme as would occur to those having skill in the art can be utilized to achieve a wide ranging color spectrum. Those having ordinary skill in the art will appreciate the numerous advantages of this embodiment, such as, for example, an ability to dynamically adjust lighting system 12 and LEDs 23 to illuminate various products in the best light color possible.

In a second exemplary embodiment of flowchart 50, the product data information 22 indicates a display life of the product whereby an implementation of flowchart 50 illuminates the product upon an expiration of a display life of the product via a light flickering or a color change by lighting system 12 and/or LEDs 23. This visual indication of the display life of the product enables a consumer to make an informed decision as to whether to purchase the product and enables a store owner to timely remove the product from display.

In a third exemplary embodiment of flowchart 50, the product data information 22 indicates whether a product is being offered under a promotional program or the like whereby an implementation of flowchart 50 illuminates each product being promoted via a highlighting color (e.g., blue) by lighting system 12 and/or LEDs 23 while other products are illuminated by a white light. This visual indication of the promoted products enables a consumer to differentiate between products under the promotional program and products not within the promotional program.

For a second set of product lighting solutions, central computer 10, reader/receiver 11 and integrated circuit 20 implement a flowchart 60 (FIG. 5) having a stage S62 involving an obtaining of a current pricing information on a product and a stage S64 involving an update of the product data information 22 based on the current pricing information.

For a third set of product lighting solutions, central computer 10, reader/receiver 11 and integrated circuit 20 implement a flowchart 70 (FIG. 6) having a stage S72 involving a reading of product shopping list 42 and a stage S74 involving a control of lighting system 12 and/or LEDs 23 to illuminate one or more products listed on product shopping list 42 whenever shopping list 40 is within range of the listed product(s) as exemplarily illustrated in FIG. 8.

For a set of personal lighting solutions, central computer 10, reader/receiver 11 and integrated circuit 20 implement a flowchart 80 (FIG. 6) having a stage S82 involving a reading of personal data information 32 and a stage S84 involving a control of lighting system 12 and/or LEDs 23 to illuminate one or more products based on the personal data information 32 whenever personal tag 30 is within range of the listed product(s) as exemplarily illustrated in FIG. 9. Personal data information 32 can include information indicative of a person's physical abilities to thereby customize the lighting level of the product illumination and/or information indicative of one or more product(s) of interest to the person to thereby illuminate such product(s) for the person. Thus, for example, a car 90 as illustrated in FIG. 9 may have a brighter illumination for people above a certain age as indicated by their personal data information 32 as opposed to the illumination of car 90 for people below that certain age as indicated by their personal data information 32. Also, by example, car 90 may have a particular illumination color as preferred by the holder of personal tag 30.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A wireless system, comprising:
a product tag (20) including means (21, 22) for indicating one color within a color spectrum for illuminating a product on display; and
means (10, 11, 13, 21, 23) for illuminating the product on display in accordance with the one color indicated by the product tag.

2. The wireless system of claim 1, wherein a differential addressing scheme is used to obtain a wide ranging color spectrum.

3. The wireless system of claim 1, wherein the illumination of the product on display is based on a set of primary colors including red, green and blue.

4. A wireless system, comprising:
a product tag (20) including means (21, 22) for indicating a display life of a product on display; and
means (10, 11, 13, 21, 23) for illuminating the product on display in accordance with the display life indicated by the product tag.

5. The wireless system of claim 4, wherein the illumination of the product is achieved by at least one of a flickering light upon an expiration of the display life and a light color change upon the expiration of the display life.

6. The wireless system of claim 4, wherein the illumination of the product on display is based on a set of primary colors including red, green and blue.

7. A wireless system, comprising:
a product tag (20) including means (21, 22) for indicating a promotion of a product on display; and
means (10, 11, 13, 21, 23) for illuminating the product on display in accordance with the promotion of the product as indicated by the product tag.

8. The wireless system of claim 7, wherein a color contrast between the product on display and other products ambient the product on display signifies the promotion of the product on display.

9. The wireless system of claim 7, wherein the illumination of the product is achieved by at least one of a flickering light and a light color change.

10. The wireless system of claim 7, wherein the illumination of the product on display is based on a set of primary colors including red, green and blue.

11. A wireless system, comprising:
a product tag (20) including means (21, 22) for indicating a current price of a product on display; and
means (10, 11, 13, 21, 23) for updating the current price of the product on display.

12. A wireless system, comprising:
a shopping list (40) including means (41, 42) for indicating at least one product to be purchased; and
means (10, 11, 13, 21, 23) for illuminating each product indicated by the shopping list (40) in response to the shopping list (40) being within a particular range of the product.

13. The wireless system of claim 12, wherein the illumination of the product is achieved by at least one of a flickering light in response to the shopping list (40) being within a particular range of the product and a light color change in response to the shopping list (40) being within a particular range of the product.

14. The wireless system of claim 12, wherein the illumination of a product on the shopping list (40) is based on a set of primary colors including red, green and blue.

15. A wireless system, comprising:
a personal tag (30) including means (31, 32) for indicating at least one product of interest to a holder of personal tag (30); and
means (10, 11, 13) for illuminating a product indicated by the personal tag (30) in response to the personal tag (30) being within a particular range of the product.

16. The wireless system of claim 15, wherein the illumination of the product is achieved by at least one of a flickering light in response to the personal tag (30) being within a particular range of the product and a color change of the light in response to the personal tag (30) being within a particular range of the product.

17. The wireless system of claim 15, wherein the illumination of each product on the personal, tag (30) is based on a set of primary colors including red, green and blue.

18. A wireless system, comprising:
a personal tag (30) including means (31, 32) for an illumination preference of a product on display as a function of a holder of the personal tag (30); and
means (10, 11, 13) for illuminating the product in accordance with the illumination preference as indicated by the personal tag (30) in response to the personal tag (30) being within a particular range of the product.

19. The wireless system of claim 18, wherein the illumination of each product is achieved by at least one of a flickering light in response to the personal tag (30) being within a particular range of the product and a color change of the light in response to the personal tag (30) being within a particular range of the product.

20. The wireless system of claim 18, wherein the illumination of each product on the personal tag (30) is based on a set of primary colors including red, green and blue.
